(19) United States
(12) Patent Application Publication
(10) Pub. No.: US 2014/0241576 A1
(43) Pub. Date: Aug. 28, 2014

(54) APPARATUS AND METHOD FOR CAMERA TRACKING

(71) Applicant: Electronics and Telecommunications Research Institute, Daejeon (KR)

(72) Inventors: Jung-Jae YU, Seongnam-si Gyeonggi-do (KR); Kyung-Ho JANG, Daegu-si (KR); Hae-Dong KIM, Daejeon-si (KR); Hye-Sun KIM, Daejeon-si (KR); Yun-Ji BAN, Daejeon-si (KR); Myung-Ha KIM, Daejeon-si (KR); Joo-Hee BYON, Daejeon-si (KR); Ho-Wook JANG, Daejeon-si (KR); Seung-Woo NAM, Daejeon-si (KR)

(73) Assignee: Electronics and Telecommunications Research Institute, Daejeon (KR)

(21) Appl. No.: 14/102,096

(22) Filed: Dec. 10, 2013

(30) Foreign Application Priority Data
Feb. 28, 2013 (KR) 10-2013-0022520

(51) Int. Cl. G06T 7/20

(52) U.S. Cl. CPC G06T 7/2033
USPC 382/103

(57) ABSTRACT

A camera tracking apparatus including a sequence image input unit configured to obtain one or more image frames by decoding an input two-dimensional image, a two-dimensional feature point tracking unit configured to obtain a feature point track by extracting feature points from respective image frames obtained by the sequence image input unit, and comparing the extracted feature points with feature points extracted from a previous image frame, to connect feature points determined to be similar, and a three-dimensional reconstruction unit configured to reconstruct the feature point track obtained by the two-dimensional feature point tracking unit.

### CROSS-REFERENCE TO RELATED APPLICATION

This application claims the benefit under 35 U.S.C. §119(a) of Korean Patent Application No. 10-2013-0022520, filed on Feb. 28, 2013, the entire disclosure of which is incorporated herein by reference for all purposes.

### BACKGROUND

1. Field

The following description relates to an apparatus and method for camera tracking, and more particularly, to an apparatus and method for predicting a camera motion at a point in time when an image is photographed, and three-dimensional coordinates of feature points included in a still background region, from an input two-dimensional moving image.

2. Description of the Related Art

Image-based camera tracking refers to technology for extracting camera motion information and three-dimensional point information of a still background image from an input two-dimensional moving image.

A system for inserting a Computer Graphic (CG) element into a live action footage image in a process of making movies, advertisements and broadcasting contents needs to recognize motion information of a filming camera, move a virtual camera in a CG working space as the filming camera moves according to the motion information, and render a CG object. The camera motion information used in this case needs to precisely coincide with the motion of the camera at a point in time when the camera actually films so as to provide the impression that the live action footage image and the CG element are filmed in the same space. Accordingly, there is a need for an image-based camera tracking operation to extract translation and rotation information of a camera during filming.

At a filming location, commercial match moving software such as Boujou and PFtrack is generally used to perform camera tracking work. Such camera tracking represents 2D-to-3D conversion work of generating a stereoscopic image from an input two-dimensional moving image, and consists of three stages including rotoscoping, depth map generation, and hole painting. In order to reduce fatigue when watching a stereoscopic image, a consistent depth between motion parallax due to camera motion and stereoscopic parallax needs to be generated in the depth map generating stage. To this end, in the depth map generating stage, first, camera tracking is performed on an input two-dimensional moving image to calculate camera motion and point coordinates of a background region in a three dimensions, and a depth map consistent with such space information is generated in a semi-automatic or manual scheme.

A Multiple-View Geometry (MVG) based camera tracking scheme consists of a two-dimensional feature tracking stage of extracting a two-dimensional feature track from an input sequence of images, a three-dimension reconstruction stage of calculating camera motion information and three-dimensional point coordinates by use of geometric characteristics of the feature track that are consistent in a three-dimensional space, and a bundle adjustment stage for optimization.

In two-dimensional feature tracking, a feature tracking scheme of detecting an optimum feature point for tracking and using Lucas Kanade Tomsi (LKT) tracking in a pyramid image has been commonly used. In the recent years, a Scale Invariant Feature Transform (SIFT) that is robust against a long base-line of a camera, and a Speed Up Robust Feature (SURF) that has improved speed, have been developed and applied to camera tracking and augmented reality applications. As for the three-dimensional reconstruction stage, Hartely has done comprehensive work on a Structure from Motion (hereinafter, referred to as SfM) scheme of calculating a fundamental matrix and a projection matrix from extracted two-dimensional feature tracks to calculate camera motion and three-dimensional points, and Pollefeys has published about image-based camera tracking technology having a handheld camcorder moving image as an input. The bundle adjustment stage, that is, the third stage, uses a sparse bundle adjustment that minimizes error between an estimated position reprojected by camera information and three-dimensional points predicted using a sparse matrix, and an observed position in two-dimensional feature tracking.

In order to obtain high-quality results in CG/live action synthesis work and 2D-to-3D conversion work, camera tracking and three-dimensional reconstruction needs to be performed under various two-dimensional image capturing conditions, such as occlusion, in which a still background is hidden by a moving object, and blurring. That is, in order to obtain three-dimensional reconstruction results having high reliability, there is need for a function to automatically connect pieces of a feature point track that are disconnected under the above undesirable conditions. In addition, when most of the feature point tracks are disconnected due to abrupt camera shaking, and three-dimensional reconstruction is performed, two independent three-dimensional reconstruction results are obtained before/after a corresponding frame.

### SUMMARY

The following description relates to an apparatus and method for camera tracking that are capable of improving the precision and efficiency of three-dimensional reconstruction by automatically connecting feature point tracks that are broken into pieces under various two-dimensional image capturing conditions, such as an occlusion, in which a still background is hidden by a moving object, and blurring.

The following description relates to an apparatus and method for camera tracking, capable of preventing two independent three-dimensional reconstruction reproduction results from being generated when most of the feature point tracks are disconnected due to abrupt camera shaking.

In one general aspect, a camera tracking apparatus includes a sequence image input unit, a two-dimensional feature point tracking unit, and a three-dimensional reconstruction unit. The sequence image input unit may be configured to obtain one or more image frames by decoding an input two-dimensional image. The two-dimensional feature point tracking unit may be configured to obtain a feature point track by extracting feature points from each of the image frames obtained by the sequence image input unit, and by comparing the extracted feature points with feature points extracted from a previous image frame to connect feature points that are determined to be similar. The three-dimensional reconstruction unit may be configured to reconstruct the feature point track obtained by the two-dimensional feature point tracking unit.

In another general aspect, a camera tracking method includes obtaining one or more image frames by decoding an input two-dimensional image, tracking a feature point track by extracting feature points from each of the obtained image frames, comparing the extracted feature points with feature points extracted from a previous image frame to connect feature points that are determined to be similar, and reconstructing the obtained feature point track.

Other features and aspects will be apparent from the following detailed description, the drawings, and the claims.

### BRIEF DESCRIPTION OF THE DRAWINGS

FIG. 1 is a block diagram illustrating a configuration of a camera tracking apparatus in accordance with an example embodiment of the present disclosure.

FIGS. 2A and 2B are drawings illustrating an example of generating a mask region.

FIG. 3 is a drawing illustrating an example of adding new feature points differently to each block region.

FIG. 4 is an example of a feature point track distribution according to frames.

FIGS. 5A to 5D are drawings illustrating an example of selecting a feature point track.

FIGS. 6A and 6B are drawings illustrating a case in which a plurality of features which have disappeared and are observed again.

FIGS. 7A and 7B are drawings illustrating designation of an approximate position and shape of a selected area.

FIGS. 8A and 8B are drawings illustrating a matching range and a matching result.

FIG. 9 is a drawing illustrating a detailed configuration of a three-dimensional reconstruction unit in accordance with an example embodiment of the present disclosure.

FIGS. 10A and 10B are drawings visualizing two-dimensional feature point tracking, three-dimensional reconstruction, and a result of bundle adjustment.

FIG. 11 is a flowchart showing a camera tracking method in accordance with an example embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. In addition, terms described below are terms defined in consideration of functions in the present invention and may be changed according to the intention of a user or an operator or conventional practice. Therefore, the definitions must be based on content throughout this disclosure.

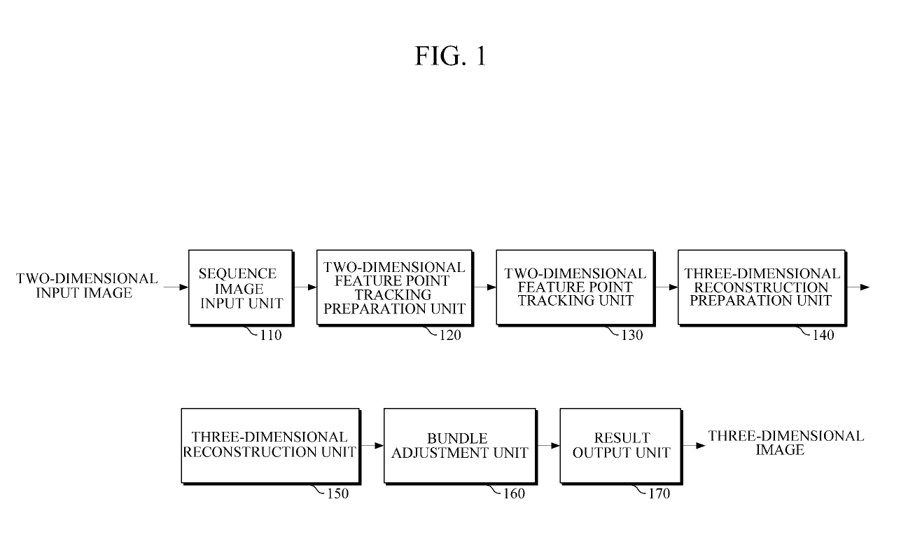

FIG. 1 is a block diagram illustrating a configuration of a camera tracking apparatus in accordance with an example embodiment of the present disclosure.

Referring to FIG. 1, a camera tracking apparatus includes a sequence image input unit 110, a two-dimensional feature point tracking preparation unit 120, a two-dimensional feature point tracking unit 130, a three-dimensional reconstruction preparation unit 140, a three-dimensional reconstruction unit 150, a bundle adjustment unit 160, and a result output unit 170.

First, to sum up the features of the present disclosure for ease of understanding, the two-dimensional feature point tracking unit 130 uses a feature matching scheme of detecting feature points, such as a Speed Up Robust Feature (SURF), at each frame, and finding and connecting similar feature points from previous/next frames or from adjacent frames within a predetermined range, rather than using an optical flow estimation scheme using Good features, and Lukas-Kanade Tracking (LKT). The feature matching scheme has a benefit of having the two-dimensional feature point tracking unit 130 automatically reconnect feature points of a track which are disconnected due to occlusion by a foreground object or blurring, within a predetermined period of time. In addition, in a case in which two-dimensional feature points are tracked and a plurality of feature points collectively disappear due to severe camera shaking and blurring, and after a predetermined time passes, the feature points that disappeared are observed again, the three-dimensional reconstruction preparation unit 140 may connect the disconnected camera tracks by manual intervention via a graphic user interface (GUI). For convenience sake, the SURF feature point detection and matching is taken as an example in the following description, but the effects of the present disclosure may be obtained even with other types of quasi feature point detection and matching schemes, for example, a scale-invariant feature transform (SIFT).

Referring to FIG. 1, the sequence image input unit 110 loads and decodes an input two-dimensional image, thereby obtaining image data of each frame for use. Here, the two-dimensional image may be consecutive two-dimensional still images, such as JPG and TIF, or a two-dimensional moving image, such as Mpeg, AVI, and MOV. Accordingly, the sequence image input unit 110 performs decoding according to the image format.

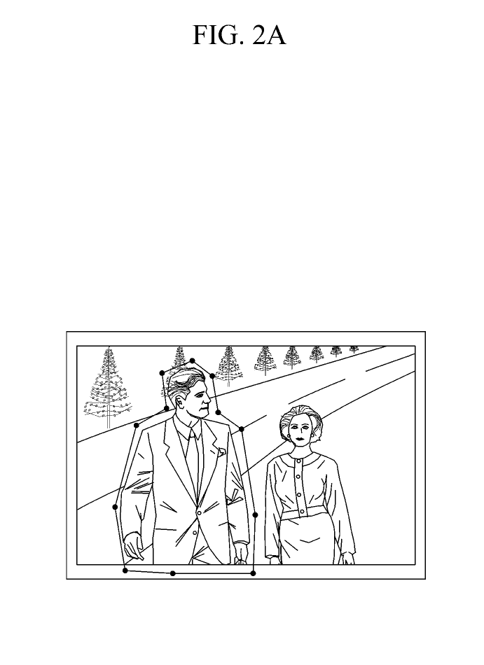

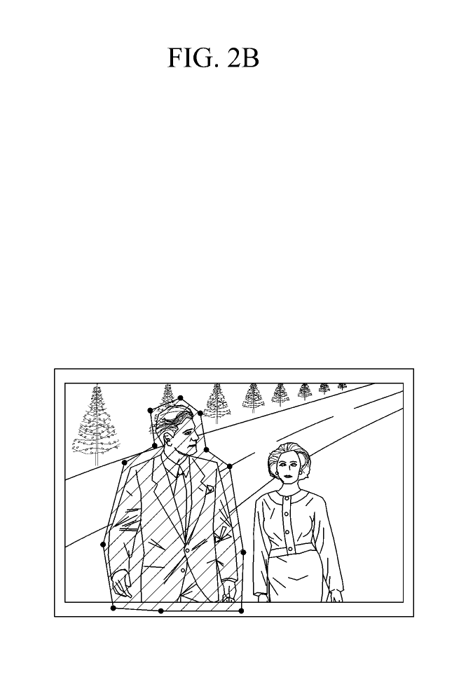

The two-dimensional feature point tracking preparation unit 120 adjusts an algorithm parameter value that is to be used in the two-dimensional feature point tracking unit 120 and generates a mask region. In this case, the adjusted parameters may include the sensitivity of feature point detection, the range of adjacent frames to be matched, and a matching threshold value. In addition, in order to improve the accuracy of the results of final camera tracking as well as the operation speed, the two-dimensional feature point track that is to be used in the three-dimensional reconstruction needs to be extracted from a still background region rather than a moving object region, and thus a dynamic foreground object region is masked. The details thereof will be described with reference to FIG. 2 later.

The two-dimensional feature point tracking unit 130 obtains a feature point track by extracting feature points from respective image frames obtained by the sequence image input unit 110, and comparing the extracted feature points with feature points extracted from a previous image frame to connect feature points that are determined to be similar. In accordance with an example embodiment of the present disclosure, the two-dimensional feature point tracking unit 130 extracts SURF feature points and connects feature points discovered to be similar to each other by performing SURF matching, which involves comparing a SURF descriptor between the feature points. The details of SURF matching will be described later.

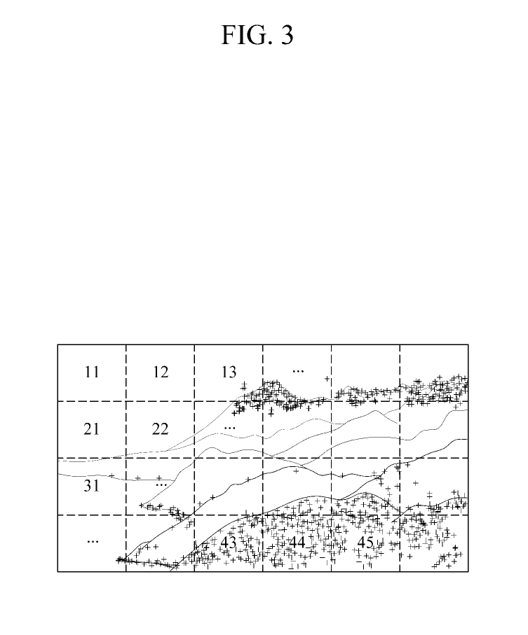

In addition, the two-dimensional feature point tracking unit 130 regards feature points not connected even after comparison with an adjacent frame, among feature points detected in a current frame, as new feature points that are newly discovered in the current frame, and adds the newly discovered feature points to a new feature point track that starts from the current frame. In this case, all the new feature points are not added, an input image is divided into a plurality of blocks, and some feature points are added to be included in each block so that the number of feature tracks are kept more than a predefined minimum value. This will be described in detail with reference to FIG. 3 later.

The two-dimensional feature point tracking unit 130 compares the added new feature points with feature points of the previous frame for connection.

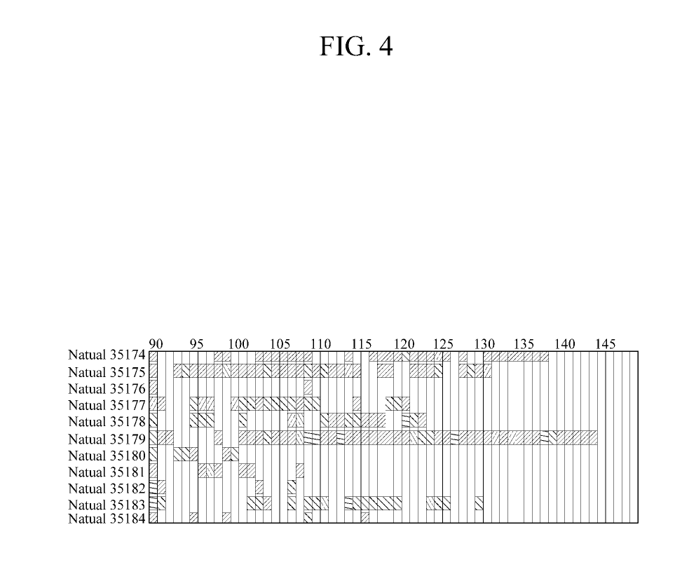

The two-dimensional feature point tracking unit 130 obtains the feature point track by the above described connection, and a feature point track distribution will be described with reference FIG. 4 later.

The three-dimensional reconstruction preparation unit 140 adjusts an option for the three-dimensional reconstruction unit 150, and designates parameter values. To this end, the three-dimensional reconstruction unit 140 automatically loads an image pixel size and a film back (the physical size of a CCD sensor inside a camera that photographs an image) from an image file, and displays the image pixel size and the film back on a screen so as to be adjusted through user input. In addition, prior information about camera motion and focal distance may be adjusted through user input.

In addition, the three-dimensional reconstruction preparation unit 140 may allow the results of the two-dimensional feature point tracking unit 130 to be edited by a user. To this end, two editing functions are provided.

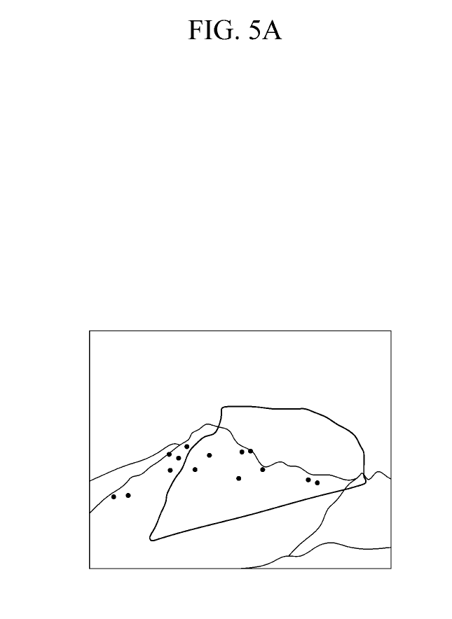

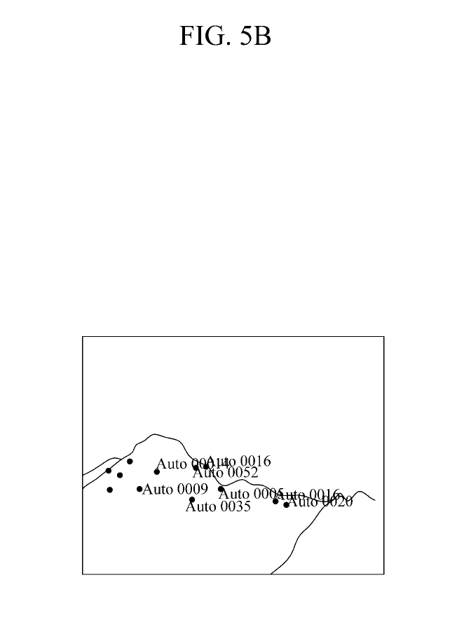

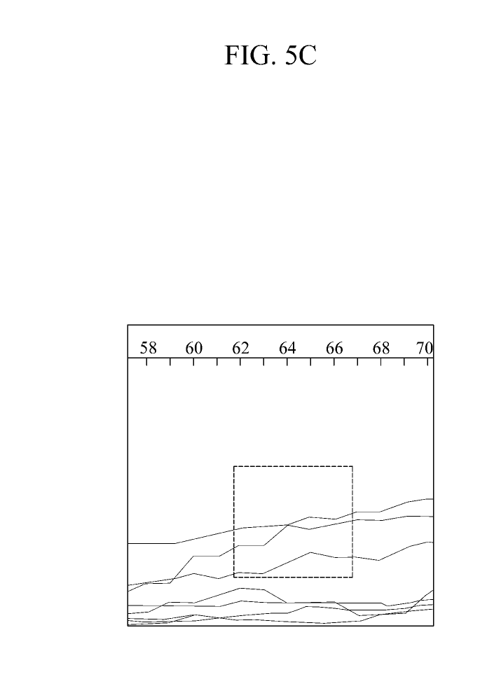

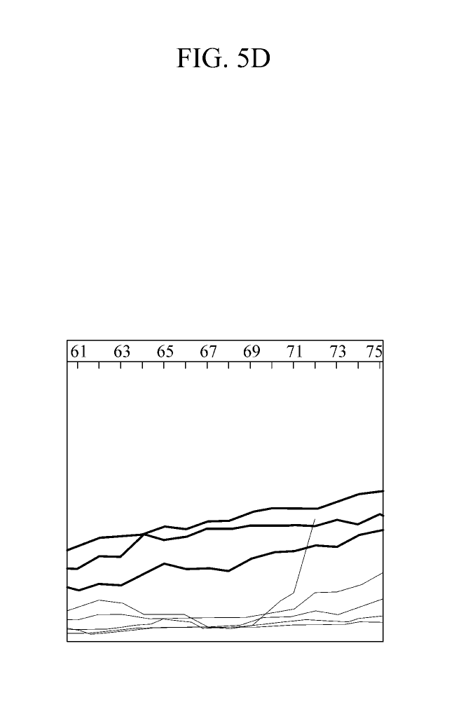

In the first editing function, the three-dimensional reconstruction preparation unit 140 displays an error graph of quantitative results of the two-dimensional feature point tracking unit 130, on a screen, and allows unnecessary feature point tracks to be selected and removed according to user input. The details thereof will be described with reference to FIG. 5 later.

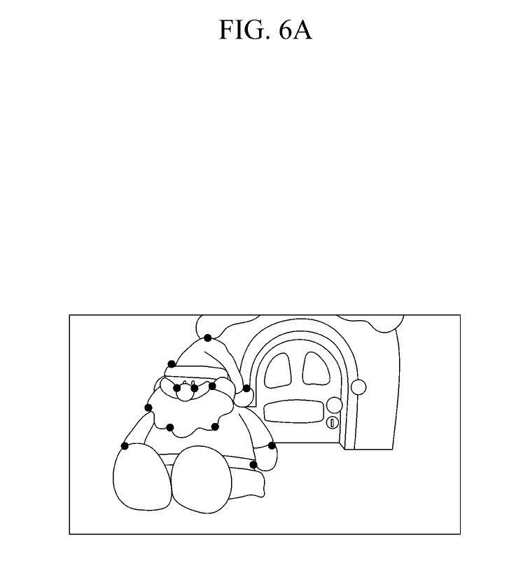

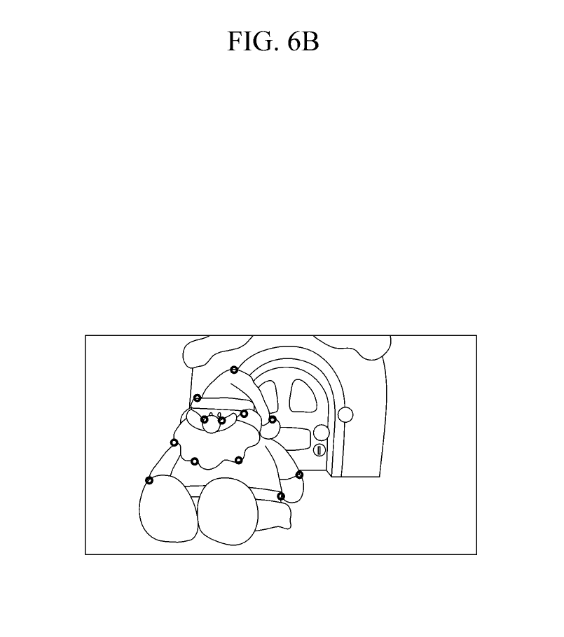

In the second editing function, when most of the feature point tracks are disconnected due to severe camera shaking and occlusion due to a foreground object adjacent to a camera, the three-dimensional reconstruction preparation unit 140 displays an editing UI on a screen, and allows a plurality of feature points to be subjected to group matching and connected according to user input. The details thereof will be described later with reference to FIGS. 6 to 8 illustrating stepwise examples.

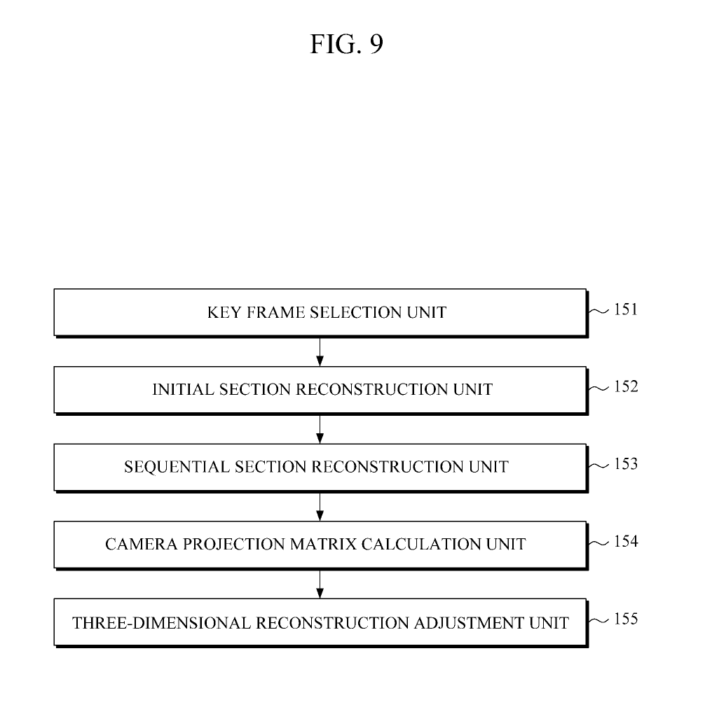

The three-dimensional reconstruction unit 150 reconstructs the obtained feature point track in three dimensions. The detailed configuration of the three-dimensional reconstruction unit 150 will be described with reference to FIG. 9 later.

The bundle adjustment unit 160 adjusts a calculation result of the three-dimensional reconstruction unit 150 so that the sum of an error between the feature point track coordinates obtained by the two-dimensional feature point tracking unit 130 and the estimated coordinates projected according to the calculation result of the three-dimensional reconstruction unit 150 is minimized.

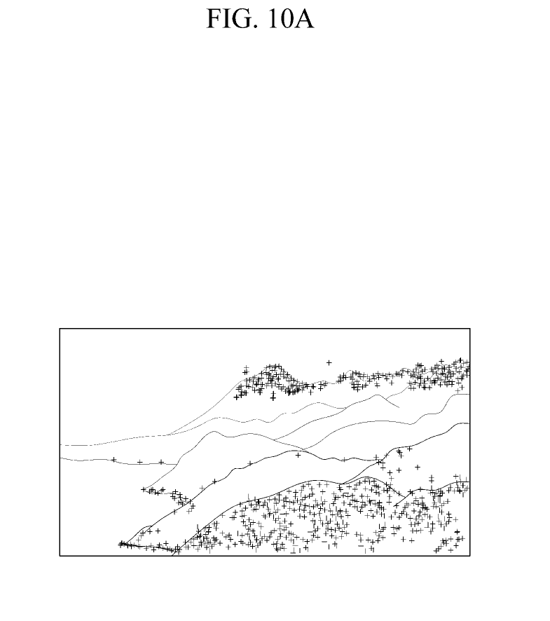

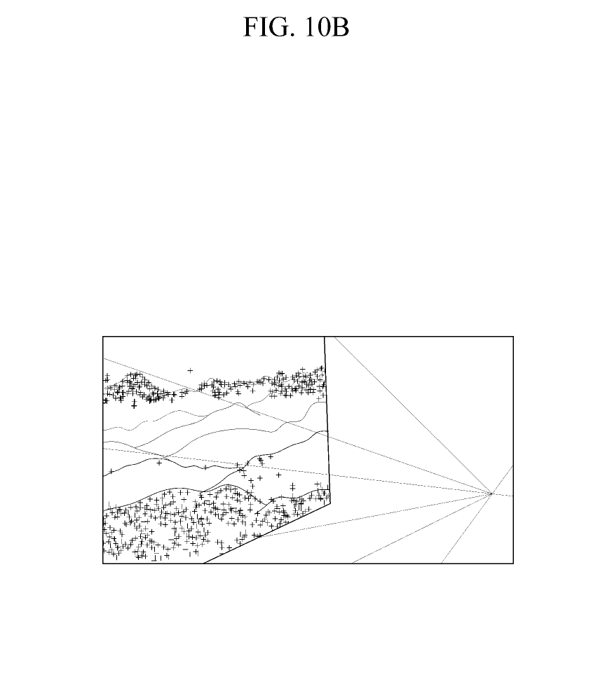

The results output unit 170 displays the feature point tracks, which are results of the two-dimensional feature point tracking unit 130, on a screen while overlapping each feature point on an image plane, and illustrates camera motion information and three-dimensional points, which are results of the bundle adjustment unit 160, in three-dimensional space. The details of the screen output by the results output unit 170 will be described with reference to FIG. 10 later.

Hereinafter, referring to FIGS. 2 to 10, the configuration of the present disclosure will be described in more detail.

FIGS. 2A and 2B are drawings illustrating an example of generating a mask region.

A mask region is a moving foreground object region in an image, and the moving foreground object region represents a region of a two-dimensional image taken of a moving object, such as a human, an animal, and vehicles. On the other hand, a still background region is a region of a two-dimensional image taken of a fixed background element, such as a building, a mountain, a tree and a wall.

Referring to FIG. 2A, the two-dimensional feature point tracking preparation unit 120 designates mask key frames according to information input by a user, and designates a control point position forming a mask region of each mask key frame. Referring to FIG. 2B, the two-dimensional feature point tracking preparation unit 120 generates a mask region by providing rotation and translation information of the entire area of the mask region. In addition, for region frames between the key frames, the control point position is calculated through linear interpolation, thereby generating a mask region. In addition, the mask region may be generated according to other schemes including the moving foreground object region, and may be used by importing previously extracted object layer region information.

Hereinafter, SURF matching will be described in detail. In accordance with an example embodiment of the present disclosure, for convenience sake, SURF matching is used, but similar effects of the present disclosure may be obtained even with other feature point detection and matching techniques.

Since SURF matching considers similarity in pixels around a feature point regardless of geometric consistency between images, a fundamental matrix and a homography matrix are calculated to exclude pairs of feature points of outliers and connect only pairs of feature points of inliers. In detail, SURF descriptors of SURF feature points detected between two adjacent frames t and t+1 are compared to each other to obtain a plurality of pairs of feature points, and a RANAC algorithm is performed using the plurality of pairs of feature points as an input to calculate a fundamental matrix and a homography matrix between the frames t and t+1. A matrix having a larger number of pairs of inlier feature points between the fundamental matrix and the homography matrix is regarded as a reference matrix, a feature point track is extended in the frame t+1 with respect to the pairs of feature points classified as inliers, and the pairs of feature points classified as outliers are not connected. The method of calculating the fundamental matrix and the homography matrix, and the concepts of the RANSAC algorithm, inliers and outliers are generally known in the art, and therefore details thereof will be omitted.

In addition, in a case in which a fundamental matrix is a reference matrix between the frames t and t+1, camera motion between the frames t and t+1 is recorded as translation+rotation, and in a case in which a homographic matrix is a reference matrix between the frames t and t+1, camera motion between the frames t and t+1 is recorded as rotation, and the recorded information is used in the three-dimensional reconstruction unit 150 later.

With respect to feature points detected from the frame t+1 that do not have similar feature points in the frame t, in the frames the range set by the two-dimensional feature point tracking preparation unit 120, starting from the nearest frame, a similar feature track is searched for among disconnected feature point tracks at each frame, and if found the similar feature is connected.

In this process, in order to exclude outliers, the homography matrix is cumulated using Equation 1 below, so as to connect only the pairs of feature points classified as inliers.

H_{t,t+M}=H_{t+M-1,t+M}* . . . *H_{t+1,t+2}*H_{t,t+1} [Equation 1]

For example, when N pairs of feature points are discovered between a frame t and a frame t+M, the cumulative homography matrix H_{t, t+M} is calculated using Equation 1, and only the pairs of feature points classified as inliers from H_{t, t+M} are connected between the frames t and t+M.

FIG. 3 is a drawing illustrating an example of adding new feature points differently to each block region.

Referring to FIG. 3, blocks 21, 22 and 31 have almost no feature point tracks included therein, and thus new feature points are added as a new feature point track. However, since blocks 43, 44 and 45 include a sufficient amount of feature point tracks, new feature points are not added to the blocks 43, 44 and 45. By adding feature point tracks in this way, new feature points are added such that the feature point tracks are distributed uniformly in space.

FIG. 4 is an example of a feature point track distribution according to frames that is finally obtained when disconnected feature point tracks are connected in the above manner.

Referring to FIG. 4, feature point tracks are newly added at a 90-frame of an input sequence image. A vertical axis is an index axis of the feature point track, and a horizontal axis represents a frame. Natural 135175, having not been observed for two frames after being added to the 90-frame, starts to be observed from a 93-frame, continues to be observed for 23 frames, and thereafter appears and disappears repeatedly several times.

In a case in which a feature point track is disconnected due to factors such as occlusion by a moving object and blurring, and the same feature point is observed again after several frames, the two-dimensional feature point tracking unit 130 serves to automatically connect the feature point. In result, a camera base-line of images having feature point tracks jointly is increased, and the precision of the three-dimensional reconstruction unit 150 calculating three-dimensional coordinates of a feature point track and camera parameters are improved.

FIGS. 5A to 5D are drawings illustrating an example of selecting a feature point track.

FIGS. 5A to 5D illustrate an example of a method of selecting feature points to be removed from an image window or an error graph window, representing a first editing function of the three-dimensional reconstruction preparation unit 140.

Referring to FIGS. 5A and 5B, feature point tracks ovelapped on the input image are displayed, and a range is designated by a user input so that some feature point tracks are selected. Referring to FIGS. 5C and 5D, a range is designated in an error graph window to select feature point tracks lying within a specific range of the error graph.

In addition, two types of selecting methods may be combined in stages for use. As shown in FIGS. 5A and 5B, first, a feature point group that is to be considered in an image is set, and an error graph is illustrated only with respect to a selected feature point group in an error graph window, and as shown in FIGS. 5C and 5D, feature points to be removed are selected by setting a range in the error graph window.

On the other hand, as shown in FIGS. 5C and 5D, first, a feature point track group that is considered in an error graph window is set, and only feature point tracks belonging to the group are illustrated in an image window, and feature point tracks to be selected and removed are selected.

FIGS. 6A and 6B are drawings illustrating a case in which a plurality of features disappear and are observed again.

In FIG. 6A, positions of feature points at a 5-frame are illustrated, and in FIG. 6B positions of feature points at a 21-frame are illustrated. The feature points, having been observed at the 5-frame, all disappeared due to server blurring for the following several frames, and are detected as feature points at the 21-frame.

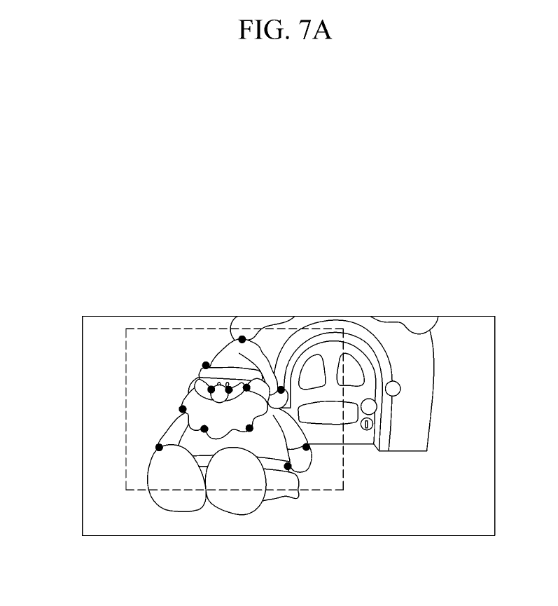

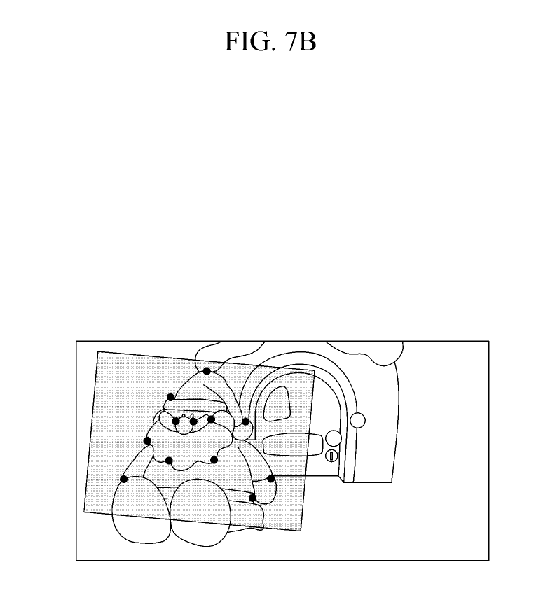

FIGS. 7A and 7B are drawings illustrating designation of an approximate change of position and shape in a selected area. In FIGS. 7A and 7B, an example of selecting a feature point group that is to be subject to group matching by an operator through a GUI, and designating a displacement of a feature point group between two frames, is illustrated.

FIG. 7A shows a selected area in the 5-frame image, and FIG. 7B shows the selected area disposed in the 21-frame image.

A dotted line shown in FIG. 7A is a ROI (Region of Interest) including a feature point group to be subject to group matching by an operator through a GUI.

Referring to FIG. 7B, an image within the ROI at the 5-frame image is shown on the 21-frame image in an overlapping manner, while approximately designating a position for ROI of the 5-frame to be disposed on the 21-frame. The operator defines a 3×3 homography matrix H group representing a two-dimensional projection transformation with respect to the selected ROI by use of the GUI of FIG. 7B.

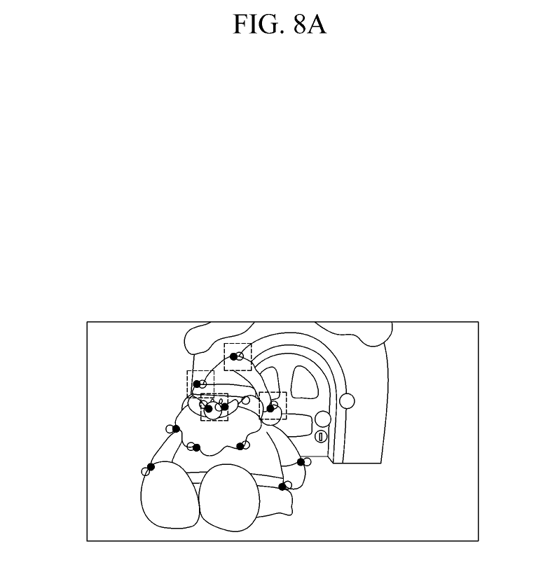

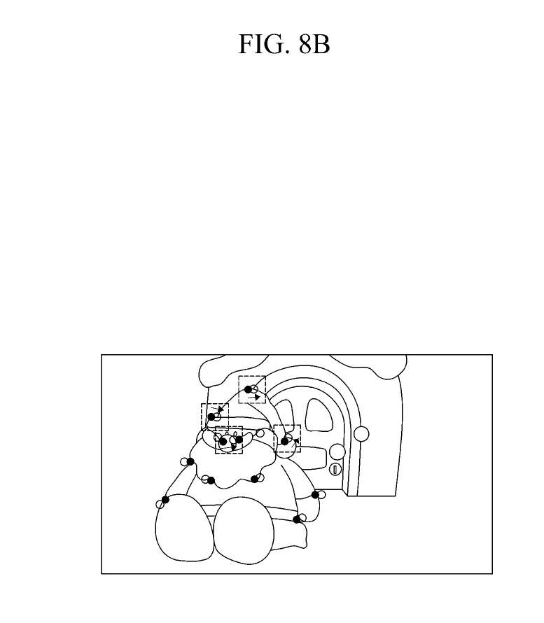

FIGS. 8A and 8B are drawings illustrating a matching range and a matching result.

Referring to FIG. 8A, a filled point represents an estimated position, {x′}₅ in the 21-frame of the feature points {x}₅ selected in the 5-frame according to the H group previously calculated, and an unfilled represents feature points {x}₂₁ detected in the 21-frame. In this case, with respect to x and x′ of {x}₅ and {x′}₅, the relationship of x′˜Hgroup*x is formed. A dotted line box of FIG. 8A illustrates a range of searching around each feature point of {x′}₅ within which matching is to be performed, and if a feature point included in the {x}₂₁ is present within the range, the most similar feature is found through SURF descriptor matching and connected as the same feature point track.

If a feature point included in the {x}₂₁ is not present within the range, and even if such a feature point is present, when the similarity obtained through matching with the most similar feature point is below a predetermined threshold, the corresponding feature point track is not connected in the 21-frame.

In FIG. 8B, the relationship between points that are determined to be the same feature point track through the above matching process is illustrated using an arrow.

FIG. 9 is a drawing illustrating a detailed configuration of a three-dimensional reconstruction unit in accordance with an example embodiment of the present disclosure.

Referring to FIG. 9, the three-dimensional reconstruction unit 150 includes a key frame selection unit 151, an initial section reconstruction unit 152, a sequential section reconstruction unit 153, a camera projection matrix calculation unit 154, and a three-dimensional reconstruction adjustment unit 155.

The key frame selection unit 151 extracts a key frame from one or more frames at intervals of a predetermined number of frames. The initial section reconstruction unit 152 performs three-dimensional reconstruction on an initial section formed of two first key frames. The sequential section reconstruction unit 153 expands the three-dimensional reconstruction in a key frame section following the initial section. The camera projection matrix calculation unit 154 calculates camera projection matrixes of remaining intermediate frames except for the key frame.

The three-dimensional reconstruction adjustment unit 155 optimizes camera projection matrixes and reconstruction three-dimensional point coordinates of entire frames such that a total reprojection error is minimized.

In this case, a section divided by the key frames serves as a reference section at which three-dimensional reconstruction is performed first, and from which the three-dimensional reconstruction expands in stages. However, the precision of the results of an algorithm of reconstructing the three-dimension from a two-dimensional image based on a Structure from Motion (SfM) of Multiple-View Geometry (MVG) depends on the amount of motion parallax caused by translation of a filming camera. Accordingly, the key frame selection unit 151 needs to select the key frames such that each of the frame sections divided by the key frames includes a predetermined amount of camera translation or more.

Assuming that a 1-frame is a first key frame Key1, the key frame selection unit 151 sets a second key frame Key2 by calculating R through Equation 2 below.

$$\begin{matrix}{x}_{i , j} = j th {feature}^{′} s coordinates in i th frame \\ {N}_{n} = number of feature matching between 1 and n frame \\ \begin{matrix}CM ( i , i + 1 ) = 1 , if the camera motion of the frame i to i + \\ 1 is translation + rotation \\ = 0 , if the camera motion of frame i to i + \\ 1 is rotation\end{matrix} & [ Equation 2 ] \\ \begin{matrix}{Dist}_{n} = Median of track distance sum with \\ camera translation motion \\ = Median ( {\{ {\sum }_{i = 1}^{n - 1} {‖ {x}_{i , j} - {x}_{i + 1 , j} ‖}^{2} * CM ( i , i + 1 ) \}}_{j} )\end{matrix} \\ Initial Range , R = {arg min}_{n} ( {N}_{n} * {Dist}_{n} ) & \end{matrix}$$

In Equation 2, x represents coordinates (x, y) T on an image plane, and (x, y) represents coordinates of a feature point track, which is a result of the two-dimensional feature point tracking unit 130, in the vertical axis and the horizontal axis. Median ( ) is a function that returns an element arranged in the middle when input elements are arranged according to size.

According to Equation 2, Key 1 and Key 2 are calculated, and when the Key 2 is assumed to be a 1-frame, representing a starting frame in Equation 2, R is calculated from Equation 2 to set a third key frame Key 3=Key2+R, and this process is repeated so that key frames in all frame sections are calculated.

The initial section reconstruction unit 152 extracts feature point tracks observed from the two frames Key1 and Key 2 calculated by the key frame selection unit 151 to form sets of feature point coordinates {x}key1 and {x}key2 in the two frames, and based on {x}key1 and {x}key2, an essential matrix is calculated. Based on the essential matrix, projection matrixes Pkey1 and Pkey2 in the two frames are calculated, and {X}key1 and {X}key2 corresponding to {x}key1 and {x}key2 are calculated and set as {X}old. In this case, x represents coordinates (x, y) T on an image plane, and X is coordinates (X, Y, Z) T in three-dimensional space. x represents coordinates of a feature point track, which is a result of the two-dimensional feature point tracking unit 130, and X represents coordinates reconstructed in three-dimensional space.

The sequential section reconstruction unit 153 calculates Pkey_n+1 by use of information at which a set of feature point coordinates {x}key_n+1 observed in a frame section Keyn+1 following the initial section intersects with the {X}old reconstructed in the previous section. In addition, {X}new is calculated based on data that does not intersect with the {X}old, from the {x}key_n and {x}key_n+1, {X}old is updated as {X}old={X}old+{X}new, and this process is repeated for every n that satisfies ‘1<n<Nkey−1 (Nkey is the number of key frames).

The camera projection matrix calculation unit 154 calculates camera projection matrixes of frames except for the key frames. A camera projection matrix Pcur is calculated from a two-dimensional and three-dimensional relationship with respect to information at which feature point coordinates {x}cur observed in each frame Fcur except for the key frame intersect with the {X}old calculated by the sequential section reconstruction unit 153.

The three-dimensional reconstruction unit 150 adjusts the three-dimensional point set {X}old reconstructed to be optimized to a camera projection matrix set {P} in all frames.

The bundle adjustment unit 160 adjusts the {X}old and {P} such that a total error between the feature point track coordinate {x} obtained by the two-dimensional feature point tracking unit in all frames and the estimated coordinates obtained when the {X}old calculated by the three-dimensional reconstruction unit are projected according to the {P} is minimized. For detailed implementation thereof, refer to Appendix 6 of [1].

The results output unit 170 illustrates the feature point track, which is a result of the two-dimensional feature point tracking unit, on the image plane in an overlapping manner (see FIG. 10A), and illustrates the camera motion information and the 3D points, which are results of the bundle adjustment unit, in three-dimensional space. FIG. 10B shows a function to convert the feature point track, the camera motion and the three-dimensional point data into an importable format in a commercial tool, such as Maya and NukeX, and then export the feature point track, the camera motion and the three-dimensional point data.

FIGS. 10A and 10B are drawings visualizing two-dimensional feature point tracking, three-dimensional reconstruction, and a result of bundle adjustment.

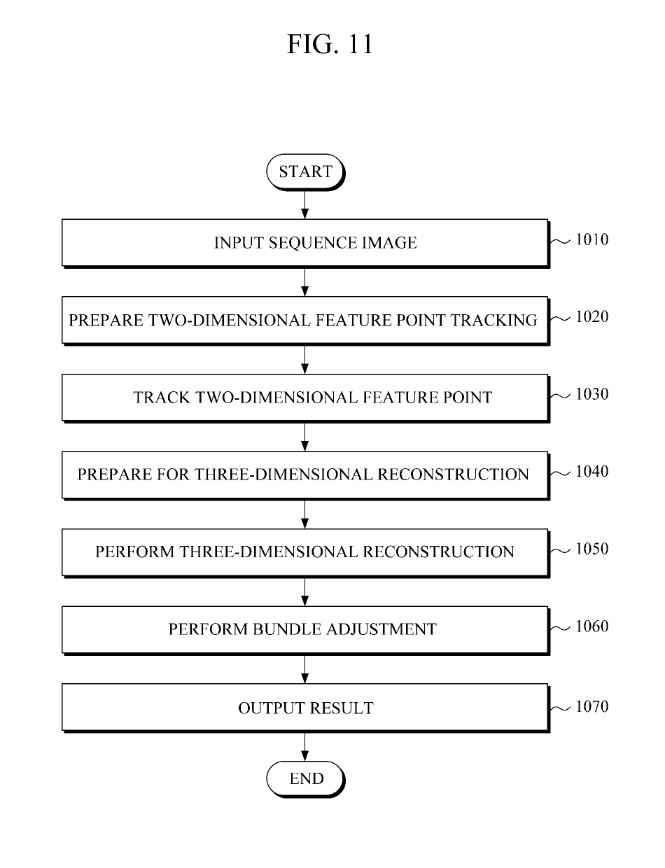

FIG. 11 is a flowchart showing a camera tracking method in accordance with an example embodiment of the present disclosure.

Referring to FIG. 11, a camera tracking apparatus loads and decodes an input two-dimensional image, thereby obtaining image data of each frame for use (1010). Here, the two-dimensional image may be a consecutive two-dimensional still image, such as JPG and TIF, or a two-dimensional moving image, such as Mpeg, AVI, and MOV. Accordingly, the sequence image input unit performs decoding according to the image format.

The camera tracking apparatus adjusts an algorithm parameter value to be used in two-dimensional feature point tracking and generates a mask region (1020). In this case, the adjusted parameters may include the sensitivity of feature point detection, the range of adjacent frames to be matched, and a matching threshold value. In addition, in order to improve the accuracy of the results of final camera tracking as well as the operation speed, the two-dimensional feature point track to be used in the three-dimensional reconstruction needs to be extracted from a still background region rather than a moving object region, and thus a dynamic foreground object region is masked.

The camera tracking apparatus obtains a feature point track by extracting feature points from the obtained respective image frames, and comparing the extracted feature points with feature points extracted from a previous image frame to connect feature points that are determined to be similar (1030). In accordance with an example embodiment of the present disclosure, the camera tracking apparatus extracts SURF feature points and connects feature points discovered to be similar to each other by performing SURF matching, which involves comparing a SURF descriptor between the feature points. In addition, the camera tracking apparatus regards feature points not connected even after comparison with an adjacent frame, among feature points detected in a current frame, as new feature points that are newly discovered in the current frame, and adds the newly discovered feature points to a new feature point track that starts from the current frame. In this case, all the new feature points are not added, an input image is divided into a plurality of blocks, and a predetermined number of new feature points are added to be included in each block. The added new feature points are compared with the feature points of the previous frame and connected.

The camera tracking apparatus adjusts an option for three-dimensional reconstruction, and designates parameter values (1040). To this end, the three-dimensional reconstruction unit 140 automatically loads an image pixel size and a film back (the physical size of a CCD sensor inside a camera that has photographed an image) from an image file, and displays the image pixel size and the film back so as to be adjusted through user input. In addition, prior information with respect to the camera motion and focal distance may be adjusted through user input.

In addition, the camera tracking apparatus may allow the results of the two-dimensional feature point tracking unit 130 to be edited by a user. To this end, two editing functions are provided.

In the first editing function, the camera tracking apparatus displays a change of a feature point block (upper, lower, left and right side pixels around a feature point within a predetermine range) or an error graph of quantitative results of the two-dimensional feature point tracking, on a screen, and allows unnecessary feature point tracks to be selected and removed according to user input.

In the second editing function, when most of the feature point tracks are disconnected due to severe camera shaking and occlusion due to a foreground object adjacent to a camera, the camera tracking apparatus displays an editing UI on a screen, and allows a plurality of feature points to be subjected to group matching and connected according to user input.

The camera tracking apparatus reconstructs the obtained feature point track in three dimensions (1050). Although not shown, operation 1050 includes extracting a key frame from one or more frames at intervals of a predetermined number of frames, performing three-dimensional reconstruction on an initial section formed of two first key frames, expanding the three-dimensional reconstruction in a key frame section following the initial section, calculating camera projection matrixes of remaining intermediate frames except for the key frame, and obtaining camera projection matrixes and reconstruction three-dimensional point coordinates of entire frames that minimize a total reprojection error.

The camera tracking apparatus adjusts a calculation result value of the three-dimensional reconstruction so that the sum of all error between the feature point track coordinates obtained in all frames in the two-dimensional feature point tracking and the estimated coordinates projected according to the calculation result of the three-dimensional reconstruction is minimized (1060).

The camera tracking apparatus displays the feature point tracks, which are results of the two-dimensional feature point tracking, on a screen while overlapping each feature point track on an image plane, and illustrates camera motion information and three-dimensional points, which are results of the bundle adjustment, in a three-dimensional space.

As is apparent from the present disclosure, when the image-based camera tracking apparatus is used, feature point tracks disconnected into pieces due to occlusion, in which a still background is hidden by a moving object, and blurring, are automatically connected, so that the camera base-line of the frame regions having the feature point tracks is expanded and thus the precision of the three-dimensional points calculated through trigonometry is improved.

In addition, in a case in which most of the feature point tracks are disconnected due to severe camera shaking, a conventional three-dimensional reconstruction produces two three-dimensional reconstruction results that are disconnected before and after a corresponding frame. The present disclosure provides an editing function to collectively connect a plurality of feature points in an efficient manner in the above situation, thereby obtaining a consistent three-dimensional reconstruction result in the above situation.

In addition, an improved key frame selecting method is provided, so that only the minimum number of key frame sections are reconstructed when an input moving image is reconstructed in three-dimensions, and the reconstruction may be automatically performed on a moving image in which only rotation occurs without translation of a camera in some frames.

In addition, the results of the present disclosure may be used to extract three-dimensional spatial information from an input two-dimensional moving image in CG/live action synthesis work and 2D-to-3D conversion work that generates a stereoscopic moving image with stereoscopic parallax from an input two-dimensional moving image.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A camera tracking apparatus comprising:
a sequence image input unit configured to obtain one or more image frames by decoding an input two-dimensional image;
a two-dimensional feature point tracking unit configured to obtain a feature point track by extracting feature points from each of the image frames obtained by the sequence image input unit, and by comparing the extracted feature points with feature points extracted from a previous image frame to connect feature points that are determined to be similar; and
a three-dimensional reconstruction unit configured to reconstruct the feature point track obtained by the two-dimensional feature point tracking unit.

2. The camera tracking apparatus of claim 1, wherein the two-dimensional feature point tracking unit extracts feature points, and connects feature points discovered to be similar to each other by performing matching comparing a descriptor that represents a shape of a feature point to distinguish feature points from one another.

3. The camera tracking apparatus of claim 1, wherein the two-dimensional feature point tracking unit connects only pairs of feature points corresponding to inliers, not pairs of feature points corresponding to outliers, by calculating a fundamental matrix and a homography matrix.

4. The camera tracking apparatus of claim 1, wherein the two-dimensional feature point tracking unit divides an input image into a plurality of blocks, and adds new features needed to keep the number of feature tracks in each block bigger than a predefined minimum value.

5. The camera tracking apparatus of claim 1, wherein the two-dimensional feature point tracking unit, in a case in which a feature point track is disconnected and then after several frames feature points coincident with the disconnected feature point track are reobserved, reconnects the feature points that are classified as inliers among the reobserved feature points in consideration of a cumulative homography matrix.

6. The camera tracking apparatus of claim 1, further comprising a three-dimensional reconstruction preparation unit configured to adjust an option for three-dimensional reconstruction and designate a parameter value.

7. The camera tracking apparatus of claim 6, wherein the three-dimensional reconstruction preparation unit edits the feature point track obtained by the two-dimensional feature point tracking unit according to user input, wherein an error graph of quantitative results of the two-dimensional feature point tracking unit are displayed on a screen, and unnecessary feature point tracks are selected and removed according to user input.

8. The camera tracking apparatus of claim 6, wherein the three-dimensional reconstruction preparation unit edits the feature point track obtained by the two-dimensional feature point tracking unit according to user input, wherein an editing user interface is displayed on a screen, and a plurality of feature points are connected through group matching according to user input.

9. The camera tracking apparatus of claim 1, wherein the three-dimensional reconstruction unit comprises:
a key frame selection unit configured to extract a key frame from one or more frames at intervals of a predetermined number of frames;
an initial section reconstruction unit configured to perform three-dimensional reconstruction on an initial section formed of two first key frames;
a sequential section reconstruction unit configured to expand the three-dimensional reconstruction in a key frame section following the initial section;
a camera projection matrix calculation unit configured to calculate camera projection matrixes of remaining intermediate frames except for the key frame; and
a three-dimensional reconstruction adjustment unit configured to obtain camera projection matrixes and reconstruction three-dimensional point coordinates of entire frames that minimize a total reprojection error.

10. A camera tracking method comprising:
obtaining one or more image frames by decoding an input two-dimensional image;
tracking a feature point track by extracting feature points from each of the obtained image frames, and by comparing the extracted feature points with feature points extracted from a previous image frame to connect feature points that are determined to be similar; and
reconstructing the obtained feature point track.

11. The camera tracking method of claim 10, further comprising:
adjusting an algorithm parameter value that is to be used in the tracking of the feature point track; and
generating a mask region.

12. The camera tracking method of claim 10, wherein in the tracking of the feature point track, feature points that are not connected, among feature points detected from a current frame, are added to a new feature point track that starts from the current frame.

13. The camera tracking method of claim 10, further comprising:
preparing for three-dimensional reconstruction by adjusting an option for the three-dimensional reconstruction and designating a parameter value.

14. The camera tracking method of claim 13, wherein in the preparing of the three-dimensional reconstruction, the feature point track obtained in the tracking of the feature point track is edited according to user input, wherein an editing user interface is displayed on a screen if the feature point track is disconnected, and a plurality of feature points are connected through group matching according to user input.

15. The camera tracking method of claim 10, wherein the preparing of the three-dimensional reconstruction comprises:
extracting a key frame from one or more frames at intervals of a predetermined number of frames;
performing three-dimensional reconstruction on an initial section formed of two first key frames;
expanding the three-dimensional reconstruction in a key frame section following the initial section;
calculating camera projection matrixes of remaining intermediate frames except for the key frame; and
obtaining camera projection matrixes and reconstruction three-dimensional point coordinates of entire frames that minimize a total reprojection error.
